(19) United States
(12) Patent Application Publication
(10) Pub. No.: US 2008/0121792 A1
(43) Pub. Date: May 29, 2008

(54) IMAGE QUALITY EVALUATION/CALCULATION METHOD, APPARATUS AND PROGRAM

(75) Inventor: Tetsurou KUSUNOKI, Ashigarakami-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 11/945,755

(22) Filed: Nov. 27, 2007

(30) Foreign Application Priority Data
Nov. 27, 2006 (JP) 2006-318391

(51) Int. Cl. G01D 18/00

(52) U.S. Cl. 250/252.1

(57) ABSTRACT

A pixel value of an evaluation region within a radiation image, which is obtained by imaging a phantom having one or more image quality evaluation patterns formed thereon with a radiation image detector, where at least one of the image quality evaluation patterns is imaged is shading-corrected using a pixel value of an uniformly exposed region adjacent to the evaluation region, and an image quality evaluation/calculation is performed using the shading-corrected pixel value of the evaluation region.

### BACKGROUND OF THE INVENTION

1. Field of the Invention

The present invention relates to an image quality evaluation/calculation method and apparatus for performing an image quality evaluation/calculation using a radiation image obtained by imaging a phantom having an image quality evaluation pattern formed thereon with a radiation image detector. The invention further relates to a computer readable recording medium on which a program for causing a computer to execute the method is recorded.

2. Description of the Related Art

Radiation image detectors that detect radiation and convert the radiation to electrical signals are known in the radiological imaging for medical diagnosis. Generally, such radiation image detectors are categorized into the following two types. One is called a CR (Computed Radiography) type detector that utilizes a storage phosphor (stimulable phosphor) which, when exposed to radiation, stores some of the radiation energy, and thereafter, when exposed to excitation light such as visible light or the like, emits stimulated luminescence according to the stored energy. In the CR type detector, a radiation image of a subject is tentatively stored in the storage phosphor sheet, then the storage phosphor sheet is scanned with excitation light such as laser light to cause stimulated luminescence emission, and image signals representing the radiation image are obtained by detecting the stimulated luminescence. The other type uses a solid state sensor which, when exposed to radiation, generates charges according to the exposed radiation energy. In the detector, a radiation image of a subject is stored by converting to charges, and the stored charges are read out using thin film transistors or a semiconductor material which generates charges when exposed to light.

In order to guarantee the reliability of the radiation images obtain by such radiation image detectors, it is necessary to measure the quality of the detectors. In general, such quality measurement is performed using a quality control phantom or the like.

The quality control phantom includes various image quality evaluation patterns formed of a synthetic resin or metal with a known radiation absorption rate, each having a predetermined size, shape, density, composition, and the like. These image quality evaluation patterns correspond to a plurality of image quality evaluation items used for the evaluation of a radiation image. By performing an evaluation on a desired image quality evaluation item, such as linearity, dynamic range, sharpness, contrast, S/N ratio, reduction ratio, or the like, using a radiation image obtained by imaging such a phantom with a radiation image detector, the quality of the radiation image detector may be measured as described, for example, in U.S. Pat. No. 7,256,392.

In the mean time, where the detection fluctuation of the image information or shading occurs due to various fluctuations including intensity fluctuation of the radiation source, sensitivity fluctuation depending on the position of the light receiving surface of the radiation image detector, and the like, if the image quality evaluation is performed for a desired image quality evaluation item using the phantom described above, the effects of the shading are added to the image quality evaluation results, resulting in an inaccurate quality measurement.

A shading correction method for eliminating effects of the shading is known as described, for example, in Japanese Unexamined Patent Publication No. 2002-209104, in which shading characteristics are obtained in advance from a radiation image obtained by uniformly exposing the entire imaging plane of a radiation image detector, i.e., performing a so-called solid exposure of the radiation image detector, and eliminates the shading from the radiation image obtained from the radiation image detector according to the shading characteristics.

In the conventional technique described above, when performing image quality evaluation using a radiation image obtained by imaging a phantom with a radiation image detector, it is necessary to newly record a radiation image obtained by uniformly exposing the entire imaging plane of the radiation image detector, i.e., performing the solid exposure of the radiation image detector in order to perform shading correction. This poses a problem that the image quality evaluation process becomes complicated, requiring more time and effort.

In view of the circumstances described above, it is an object of the present invention to provide an image quality evaluation/calculation method and apparatus capable of performing a shading correction efficiently and improving the accuracy of image quality evaluation of a radiological imaging apparatus. It is a further object of the present invention to provide a computer readable recording medium on which a program for causing a computer to execute the method is recorded.

### SUMMARY OF THE INVENTION

The image quality evaluation/calculation method of the present invention is a method including the steps of:

performing a shading correction on a pixel value of an evaluation region within a radiation image, which is obtained by imaging a phantom having one or more image quality evaluation patterns formed thereon with a radiation image detector, where at least one of the image quality evaluation patterns is imaged using a pixel value of an uniformly exposed region adjacent to the evaluation region; and

performing an image quality evaluation/calculation using the shading-corrected pixel value of the evaluation region.

In the method described above, it is preferable that the uniformly exposed region includes: a region horizontally extending at least the horizontal width of the evaluation region on at least one of the sides of the evaluation region in the vertical direction thereof; and a region vertically extending at least the vertical width of the evaluation region on at least one of the sides of the evaluation region in the horizontal direction thereof.

The image quality evaluation/calculation apparatus of the present invention is an apparatus including:

a shading correction means for performing a shading correction on a pixel value of an evaluation region within a radiation image, which is obtained by imaging a phantom having one or more image quality evaluation patterns formed thereon with a radiation image detector, where at least one of the image quality evaluation patterns is imaged using a pixel value of an uniformly exposed region adjacent to the evaluation region; and

an image quality evaluation/calculation means for performing an image quality evaluation/calculation using the shading-corrected pixel value of the evaluation region.

In the apparatus described above, it is preferable that the uniformly exposed region includes: a region horizontally extending at least the horizontal width of the evaluation region on at least one of the sides of the evaluation region in the vertical direction thereof; and a region vertically extending at least the vertical width of the evaluation region on at least one of the sides of the evaluation region in the horizontal direction thereof.

The computer readable recording medium of the present invention is a medium on which a program for causing a computer to execute an image quality evaluation calculation method which includes the steps of:

performing a shading correction on a pixel value of an evaluation region within a radiation image, which is obtained by imaging a phantom having one or more image quality evaluation patterns formed thereon with a radiation image detector, where at least one of the image quality evaluation patterns is imaged using a pixel value of an uniformly exposed region adjacent to the evaluation region; and

performing an image quality evaluation/calculation using the shading-corrected pixel value of the evaluation region.

The referent of “uniformly exposed region” as used herein means an image region where a portion of the phantom which does not include any image quality evaluation pattern is imaged, an image region without any subject imaged thereon, or an image region where a subject is imaged, but the subject has uniform composition and thickness so that the region of the radiation image detector corresponding to the image region is exposed uniformly, or the like.

According to the image quality evaluation/calculation method, apparatus, and computer readable recording medium on which a program therefor is recorded of the present invention, a shading correction is performed on a pixel value of an evaluation region within a radiation image, which is obtained by imaging a phantom having one or more image quality evaluation patterns formed thereon with a radiation image detector, where at least one of the image quality evaluation patterns is imaged using a pixel value of an uniformly exposed region adjacent to the evaluation region; and an image quality evaluation/calculation is performed using the shading-corrected pixel value of the evaluation region. This allows an image quality evaluation/calculation and a shading correction to be performed using a radiation image obtained by imaging a phantom, so that the shading correction may be performed more efficiently in comparison with the conventional method that requires another imaging taking and recording the additional image for the shading correction.

In the method described above, if the uniformly exposed region includes a region horizontally extending at least the horizontal width of the evaluation region on at least one of the sides of the evaluation region in the vertical direction thereof; and a region vertically extending at least the vertical width of the evaluation region on at least one of the sides of the evaluation region in the horizontal direction thereof, horizontal shading characteristics present in the evaluation region may be detected from the region extending the horizontal width of the evaluation region, and vertical shading characteristics present in the evaluation region may be detected from the region extending the vertical width of the evaluation region. Thus, shading corrections may be performed on the evaluation region for both the horizontal and vertical directions using the detected shading characteristics.

### BRIEF DESCRIPTION OF THE DRAWINGS

FIG. 1 is a schematic configuration diagram of the image quality evaluation/calculation apparatus according to an embodiment of the present invention.

FIG. 2 illustrates shading correction by the shading correction means shown in FIG. 1.

FIG. 3 illustrates shading correction by the shading correction means shown in FIG. 1.

FIG. 4 illustrates another embodiment of the shading correction in the shading correction means.

### DESCRIPTION OF THE PREFERRED EMBODIMENTS

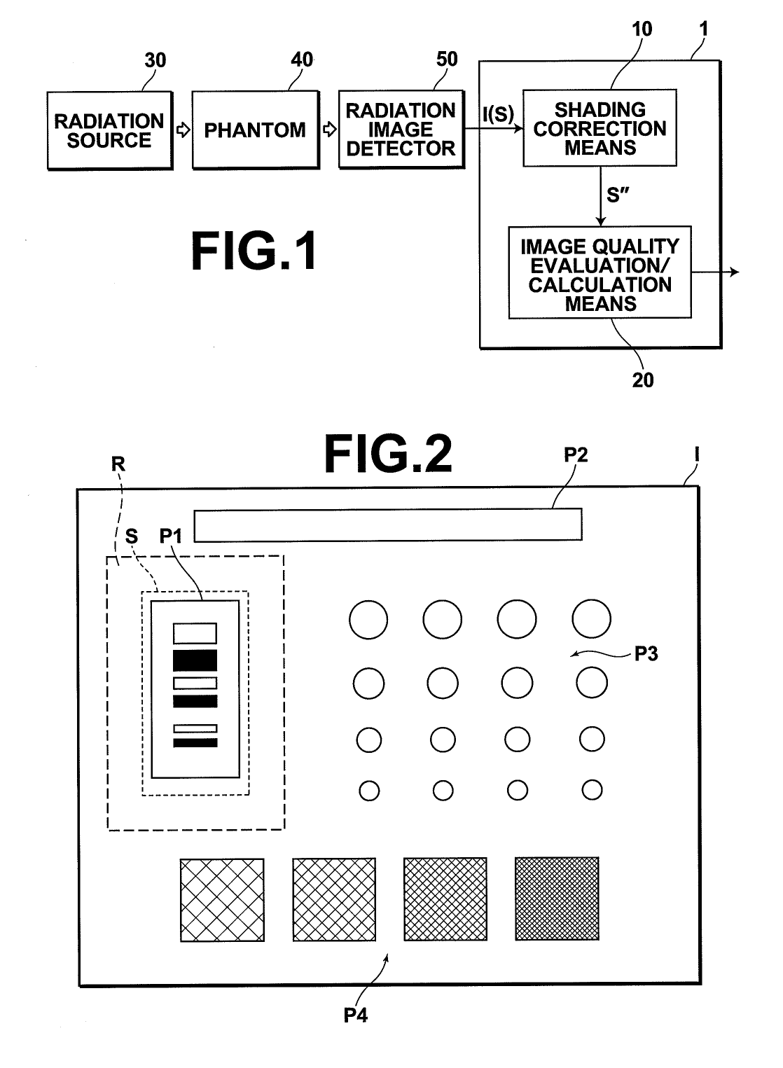

Hereinafter, exemplary embodiments of the image quality evaluation/calculation apparatus of the present invention will be described with reference to the accompanying drawings. The image quality evaluation/calculation apparatus 1 according to an embodiment of the present invention illustrated in FIG. 1 is realized by executing an image quality evaluation/calculation program, which is stored in an auxiliary storage, on a computer (e.g., personal computer, or the like). Here, the image quality evaluation/calculation program is recorded on an information recording medium, such as a CD-ROM, or distributed through a network, such as the Internet, and installed on the computer.

The embodiment shown in FIG. 1 includes: a radiation source 30 for emitting radiation; a phantom 40 having one or more image quality evaluation patterns formed thereon used for quality control of a radiation image; a radiation image detector 50 for detecting a radiation image I of the phantom 40 by receiving radiation transmitted through the phantom 40; and the image quality evaluation/calculation apparatus 1. The image quality evaluation/calculation apparatus 1 includes: a shading correction means 10 for performing a shading correction on a pixel value of an evaluation region S within the radiation image I where at least one of the image quality evaluation patterns is imaged using a pixel value of a uniformly exposed region R adjacent to the evaluation region S; and an image quality evaluation/calculation means 20 for performing image quality evaluation/calculation using the shading-corrected pixel value of the evaluation region S.

The phantom 40 includes various image quality patterns formed of a synthetic resin or metal with a known radiation absorption rate, each having a predetermined size, shape, density, composition, and the like. These image quality evaluation patterns correspond to a plurality of image quality evaluation items used for the evaluation of a radiation image, such as linearity, dynamic range, sharpness (resolution), contrast, S/N ratio, reduction ratio, and the like. By performing an evaluation on each of desired image quality evaluation items using pixel values of the regions Pn (n=1, 2, - - - ) where the image quality evaluation patterns are imaged on the radiation image I obtained by imaging the phantom 40 with the radiation image detector 50, the quality of the radiation image detector 50 may be measured.

The radiation image detector 50 obtains the radiation image I of the phantom 40 having a plurality of image quality evaluation patterns formed thereon by detecting radiation transmitted through the phantom 40, and outputs the obtained radiation image I to the shading correction means 10 of the image quality evaluation/calculation apparatus 1. As for the radiation image detector 50, the following two types of radiation image detectors and the like may be used. One is a CR type detector that utilizes a storage phosphor (stimulable phosphor) which, when exposed to radiation, stores some of the radiation energy, and thereafter, when exposed to excitation light such as visible light or the like, emits stimulated luminescence according to the stored energy. In the CR type detector, a radiation image of a subject is tentatively stored in the storage phosphor sheet, then the storage phosphor sheet is scanned with excitation light such as laser light to cause stimulated luminescence emission, and image signals representing the radiation image are obtained by detecting the stimulated luminescence. The other type of detector that may be used as the radiation image detector 50 uses a solid state sensor which, when exposed to radiation, generates charges according to the exposed radiation energy. In the detector, a radiation image of a subject is stored by converting to charges, and the stored charges are read out using thin film transistors or a semiconductor material which generates charges when exposed to light.

The shading correction means 10 performs shading correction on the pixel values of the evaluation region S where at least one of a plurality of image quality evaluation patterns of the phantom 40 is imaged within the radiation image I obtained by the radiation image detector 50 using the adjacent uniformly exposed region R. Here, as the radiation image I, a radiation image converted to a space in which the intensity ratio of the radiation transmitted through the phantom 40 is represented as difference by logarithmically converting the pixel values of the radiation image I in advance is used.

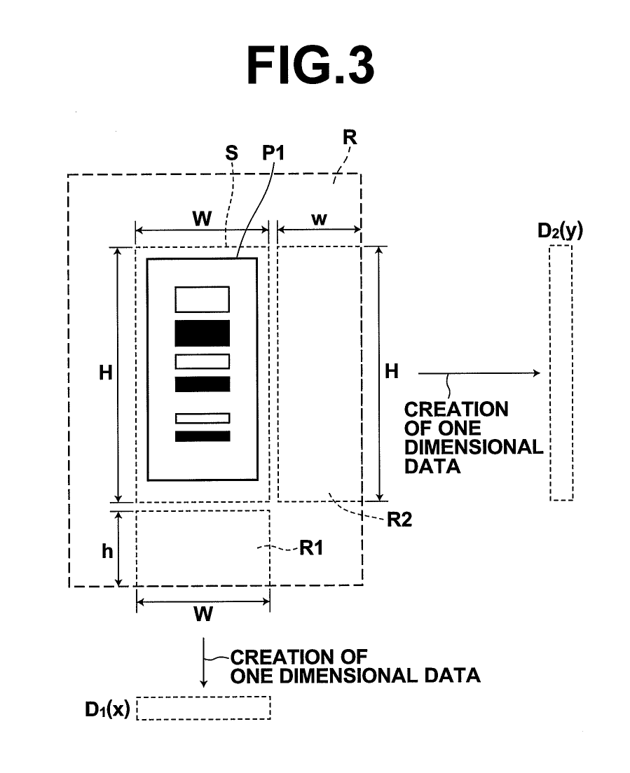

More specifically, the shading correction means 10 determines the evaluation region S, which is a rectangular region of W pixels in the horizontal direction and H pixels in the vertical direction including a region P1 within the radiation image I where at least one of the image quality evaluation patterns of the phantom 40 is imaged as illustrated in FIG. 2. Then, reference regions R1 and R2 are defined as illustrated in FIG. 3. The reference region R1 is a uniformly exposed rectangular region horizontally extending the horizontal width of the evaluation region S on one side of the evaluation region S (lower side) in the vertical direction thereof, and defined by W pixels (horizontal direction)×h pixels (vertical direction). The reference region R2 is a uniformly exposed rectangular region vertically extending the vertical width of the evaluation region S on one side of the evaluation region S (right side) in the horizontal direction thereof, and defined by w pixels (horizontal direction)×H pixels (vertical direction).

Here, the reference region R1 is a region within the uniformly exposed region R adjacent to the evaluation region S, extending the horizontal width of the evaluation region S on one side of the evaluation region S (lower side) in the vertical direction thereof, and shading characteristics of the evaluation region S in the horizontal direction may be obtained from the reference region R1. The reference region R2 is a region within the uniformly exposed region R adjacent to the evaluation region S, extending the vertical width of the evaluation region S on one side of the evaluation region S (right side) in the horizontal direction thereof, and shading characteristics of the evaluation region S in the vertical direction may be obtained from the reference region R2.

Hereinafter, a method for performing a shading correction on the evaluation region S in the horizontal and vertical directions using the reference regions R1 and R2 will be described.

First, in the reference region R1, which is a rectangular region of W pixels (horizontal direction)×h pixels (vertical direction), the average pixel value of h pixels in each of horizontally arranged W pixel columns is obtained, and one dimensional data D₁ (x), (x=1, 2, - - - , W) constituted by each of the obtained average values are created. Further, a reference average value A₁ is obtained, which is the average value of W average values constituting the one dimensional data D₁ (x).

Then, as illustrated in Formula (1) below, from the pixel value of each pixel S (x, y) of the evaluation region S, each average value, constituting the one dimensional data D₁(x), corresponding to the coordinate x of the pixel is subtracted, and then the reference average value A₁ is added thereto. This yields each pixel value S′ (x, y), which is each pixel value S (x, y) after shading-corrected in the horizontal direction.

S′(X,0)=S(x,0)−D₁(x)+A₁

S′(x,1)=S(x,1)−D₁(x)+A₁

- - -

S′(x,H)=S(x,H)−D₁(x)+A₁ (1)
(x=1, 2, - - - , W)

Likewise, in the reference region R2, which is a rectangular region of w pixels (horizontal direction)×H pixels (vertical direction), the average pixel value of w pixels in each of vertically arranged H pixel rows is obtained, and one dimensional data D₂ (y), (y=1, 2, - - - , H) constituted by each of the obtained average values are created. Further, a reference average value A₂ is obtained, which is the average value of H average values constituting the one dimensional data D₂ (y).

Then, as illustrated in Formula (2) below, from each pixel value S′ (x, y) obtained by performing the shading correction on the evaluation region S in the horizontal direction, each average value, constituting the one dimensional data D₂ (y), corresponding to the coordinate y of the pixel is subtracted, and then the reference average value A₂ is added thereto. This yields each pixel value S″ (x, y), which is horizontally shading-corrected each pixel value S′ (x, y) further shading-corrected in the vertical direction.

S″(0,y)=S′(0,y)−D₂(y)+A₂

S″(1,y)=S′(1,y)−D₂(y)+A₂

- - -

S″(W,y)=S′(W,y)−D₂(y)+A₂ (2)
(y=1, 2, - - - , H)

The pixel value S″ (x, y) of the evaluation region S obtained by performing shading correction on the evaluation region S in the horizontal and vertical directions through the arithmetic operations described above is outputted to the image quality evaluation/calculation means 20.

The evaluation region S, reference region R1, and reference region R2 may be determined by either one of the following methods. One method is to determine the positions of these regions based on the information of the shape, layout, and the like of the phantom 40 obtained in advance. The other method is to determine the evaluation region S so as to include a region where at least one image quality evaluation pattern is imaged from the regions where image quality evaluation patterns are imaged and automatically recognized from the radiation image I, then determines the reference regions R1 and R2 from a region other than the region where an image quality evaluation pattern is imaged recognized by the automatic recognition described above.

Determination of the reference regions R1 and R2 in a region away from a region where an image quality evaluation pattern is imaged by a predetermined number of pixels may eliminate the region where the pixel values are influenced by the image quality evaluation pattern.

The image quality evaluation/calculation means 20 performs image quality evaluation/calculation using the pixel value S″ (x, y) of the evaluation region S shading-corrected by the shading correction means 10. It performs an evaluation/calculation with respect to each of the desired evaluation items, such as linearity, dynamic range, sharpness (resolution), contrast, S/N ratio, reduction ratio, and the like, each corresponding to each of the image quality evaluation patterns of the phantom 40. For example, the region P1 in FIG. 2 is a region where an image quality evaluation pattern for measuring the sharpness of the radiation image I, formed of a testing member having square waves of a plurality of frequencies, is imaged. The image quality evaluation/calculation means 20 calculates CFT (Contrast Transfer Function) using pixel values of the region P1 within the evaluation region S shading-corrected by the shading correction means 10 and outputs an evaluation value for the sharpness of the radiation image I obtained based on the calculated CFT. This allows the quality for sharpness of the radiation image detector 50 to be measured. Likewise, for each of other regions where an image quality evaluation pattern, which is shading-corrected by the shading correction means 10, corresponding to each of other image quality evaluation items is imaged, an image quality evaluation/calculation may be performed by the known image quality evaluation/calculation method corresponding to each of the image quality evaluation items using the pixel values of each region, and the evaluation value for each evaluation item may be outputted.

When performing an image quality evaluation for a radiation image detector 50 using the configuration described above, it is performed through the following steps of: placing a phantom 40 having one or more image quality evaluation patterns formed thereon on the radiation image detector 50; causing the radiation source 30 to emit radiation; detecting radiation transmitted through the phantom 40 with the radiation image detector 50 to obtain a radiation image I of the phantom 40; causing the shading correction means 10 to perform a shading correction on an evaluation region S where at least one of the image quality evaluation patterns is imaged within the obtained radiation image I in the vertical and horizontal directions by determining a reference region R1 horizontally extending the horizontal width of the evaluation region S on one side of the evaluation region S in the vertical direction thereof and a reference region R2 vertically extending the vertical width of the evaluation region S on one side of the evaluation region S in the horizontal direction thereof within an uniformly exposed region adjacent to the evaluation region S, and using pixel values of the reference regions R1 and R2; and causing the image quality evaluation/calculation means 20 to perform an image quality evaluation/calculation corresponding to each of the image quality evaluation patterns using pixel values of the shading-corrected evaluation region S.

As described in detail, in the method for performing an image quality evaluation/calculation using a radiation image I obtained by imaging a phantom 40 having one or more image quality evaluation patterns formed thereon with a radiation image detector 50, pixel values of the evaluation region where at least one of the image quality evaluation pattern is imaged are shading-corrected using pixel values of an uniformly exposed region R adjacent to the evaluation region S, and an image quality evaluation/calculation is performed using pixel values of the shading-corrected evaluation region. This allows the shading correction and image quality evaluation/calculation to be performed using a single radiation image obtained by imaging a phantom, so that the shading correction may be performed more efficiently in comparison with the conventional method that requires another imaging taking and recording the additional image for shading correction. Further, the image quality evaluation/calculation is performed on the image on which a shading correction for eliminating shading is performed, so that more accurate image quality evaluation may be performed for a desired image quality evaluation item of the radiation image detector.

Further, the uniformly exposed region R includes the reference region R1 horizontally extending at least the horizontal width of the evaluation region S on at least one of the sides of the evaluation region S in the vertical direction thereof and the reference region R2 vertically extending at least the vertical width of the evaluation region S on at least one of the sides of the evaluation region S in the horizontal direction thereof, so that horizontal shading characteristics of the evaluation region may be detected from the reference region R1, and vertical shading characteristics of the evaluation region may be detected from the reference region R2. Thus, a shading correction may be performed on the evaluation region S for both the horizontal and vertical directions using the detected shading characteristics.

In the embodiment above, the description has been made of a case in which the evaluation region S is a region including a region where a single image quality pattern is imaged, but it may be a region including a plurality of image quality evaluation pattern.

Further, the description has been made of a case in which the evaluation region, reference region R1, and reference region R2 are rectangular regions, but they may have circular, elliptical, or other shapes.

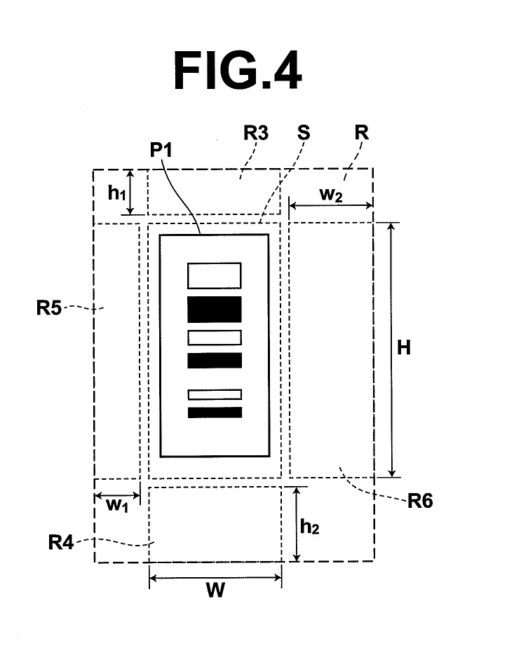

Still further, in the embodiment above, the description has been made of a case in which the shading correction means 10 performs shading corrections on the evaluation region S using the region R1 located on one side of the evaluation region S in the vertical direction thereof, and the region R2 located on one side of the evaluation region S in the horizontal direction thereof. But an arrangement may be adopted in which reference regions R3 and R4, each horizontally extending the horizontal width of the evaluation region S on each side of the evaluation region S in the vertical direction thereof, and reference regions R5 and R6, each vertically extending the vertical width of the evaluation region S on each side of the evaluation region S in the horizontal direction thereof are determined as illustrated in FIG. 4, and a shading correction is performed on the evaluation region S using pixel values of the four reference regions.

More specifically, the reference region R3, which is a rectangular region of W pixels (horizontal direction)×h1 pixels (vertical direction) and the reference region R4, which is a rectangular region of W pixels (horizontal direction)×h2 pixels (vertical direction) are connected in the vertical direction to create a rectangular region of W pixels (horizontal direction)×h (h1+h2) pixels (vertical direction) which corresponds to the reference region R1 in the embodiment described above, and the reference region R5, which is a rectangular region of w1 pixels (horizontal direction)×H pixels (vertical direction) and the reference region R6, which is a rectangular region of w2 pixels (horizontal direction)×H pixels (vertical direction) are connected in the horizontal direction to create a rectangular region of w (w1+w2) pixels (horizontal direction)×H pixels (vertical direction) which corresponds to the reference region R2 in the embodiment described above. Then, using these reference regions R1 and R2, a shading correction identical to that of the embodiment described above may be performed.

Further, an arrangement may be adopted in which median filtering is performed on the reference regions R1 and R2 to eliminate noise from the image using a median filter in which an image region (window) of, for example, 3×3 or 5×5 pixels is set adjacent to each of the pixels of the reference regions R1 and R2, and the pixel value of each pixel is replaced by the median value of all data within the window before the shading correction is performed by the shading correction means 20.

What is claimed is:

1. An image quality evaluation/calculation method comprising the steps of:
performing a shading correction on a pixel value of an evaluation region within a radiation image, which is obtained by imaging a phantom having one or more image quality evaluation patterns formed thereon with a radiation image detector, where at least one of the image quality evaluation patterns is imaged using a pixel value of an uniformly exposed region adjacent to the evaluation region; and
performing an image quality evaluation/calculation using the shading-corrected pixel value of the evaluation region.

2. The image quality evaluation/calculation method of claim 1, wherein the uniformly exposed region includes:
a region horizontally extending at least the horizontal width of the evaluation region on at least one of the sides of the evaluation region in the vertical direction thereof; and
a region vertically extending at least the vertical width of the evaluation region on at least one of the sides of the evaluation region in the horizontal direction thereof.

3. An image quality evaluation/calculation apparatus comprising:
a shading correction means for performing a shading correction on a pixel value of an evaluation region within a radiation image, which is obtained by imaging a phantom having one or more image quality evaluation patterns formed thereon with a radiation image detector, where at least one of the image quality evaluation patterns is imaged using a pixel value of an uniformly exposed region adjacent to the evaluation region; and
an image quality evaluation/calculation means for performing an image quality evaluation/calculation using the shading-corrected pixel value of the evaluation region.

4. The image quality evaluation/calculation apparatus of claim 3, wherein the uniformly exposed region includes:
a region horizontally extending at least the horizontal width of the evaluation region on at least one of the sides of the evaluation region in the vertical direction thereof; and
a region vertically extending at least the vertical width of the evaluation region on at least one of the sides of the evaluation region in the horizontal direction thereof.

5. A computer readable recording medium on which a program for causing a computer to execute an image quality evaluation/calculation method comprising the steps of:
performing a shading correction on a pixel value of an evaluation region within a radiation image, which is obtained by imaging a phantom having one or more image quality evaluation patterns formed thereon with a radiation image detector, where at least one of the image quality evaluation patterns is imaged using a pixel value of an uniformly exposed region adjacent to the evaluation region; and
performing an image quality evaluation/calculation using the shading-corrected pixel value of the evaluation region.
